(19) United States
(12) Patent Application Publication
(10) Pub. No.: US 2007/0158969 A1
(43) Pub. Date: Jul. 12, 2007

(54) Maneuverable Ambulance Chair

(76) Inventor: Nathan R. Walkingshaw, Bountiful, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/621,553

(22) Filed: Jan. 9, 2007

Related U.S. Application Data
(60) Provisional application No. 60/758,102, filed on Jan. 11, 2006.

(51) Int. Cl. B60N 2/00; B60N 2/24; B60N 2/06

(52) U.S. Cl. 296/64

(57) ABSTRACT

A maneuverable ambulance chair is disclosed that allows an ambulance attendant to safely attend to a patient because the chair is both secured to the floor, wall, or other structure of an ambulance and selectively maneuverable, allowing access to the patient at any number of positions while allowing an ambulance attendant to remain secured in the chair. A track or channel allows an ambulance attendant to selectively position the chair at any position along the track. The rear portion of an ambulance is also configured to facilitate the convenient access of both medical supplies and the patient, without requiring the ambulance attendant to leave the chair or sacrifice protection of the ambulance attendant against crashes or sudden unwanted ambulance movement.

### CROSS-REFERENCE TO RELATED APPLICATIONS

This application claims priority to U.S. Provisional Patent Application No. 60/758,102, filed Jan. 11, 2006, and entitled “Maneuverable Ambulance Chair.”

### BACKGROUND OF THE INVENTION

1. Field of the Invention

The present invention relates to a maneuverable ambulance chair. More particularly, the present invention relates to a chair that allows an ambulance attendant to safely attend to a patient because the chair is both secured to the floor, wall, or other secured structure of an ambulance and maneuverable, allowing an ambulance attendant access to the patient at any number of positions while remaining restrained in the chair.

2. Background and Related Art

The time between when an ambulance picks up a patient to when the ambulance arrives at its destination is often critical to saving a patient's life. Because of this, ambulance attendants such as Emergency Medical Technicians, Paramedics and Nurses must work feverishly en route to the hospital. Performing this life-saving work is often very dangerous to ambulance attendants because not only do ambulances travel at high speeds, but ambulance attendants are often not restrained in their seats in order to be better able to maneuver around a patient to provide life-saving care. Thus, ambulance attendants often sacrifice their own safety in order to retain the mobility needed to appropriately position themselves near the patient. In addition, ambulance attendants need to stay mobile in order to reach needed medical items that may be stored in various locations around the interior of an ambulance. Thus, a need exists for a safe way for ambulance technicians to work on patients while traveling in ambulances.

### SUMMARY OF THE INVENTION

The present invention relates to a selectively maneuverable ambulance chair. More particularly, the present invention relates to a chair that allows an ambulance attendant to safely attend to a patient because the chair is both secured to the floor, wall, or other secure structure of an ambulance and maneuverable, allowing an ambulance attendant access to the patient at any number of positions while remaining restrained in the chair.

In some embodiments, the chair is connected to a track system in the floor of the ambulance. In one such embodiment, the chair is locked into a channel or track having the ability to passively engage and actively release. In this embodiment, the chair moves along the channel. The chair and channel can be configured in a number of manners. For instance, in some embodiments, multiple chairs and channels exist. In one embodiment, two substantially straight channels exist on different sides of the patient and allow each attendant lateral mobility from either the top to the bottom of the patient or from side to side. In another embodiment, one channel exists that allows an attendant to move to any side of the patient. In yet another embodiment, the chair keeps the attendant restrained while allowing sufficient mobility for the attendant to reach from head to toe of the patient. One skilled in the relevant art would understand that any number of configurations is possible to allow sufficient mobility and appropriate attendant positioning.

In other embodiments, the chair may be mounted on an elevated track that passes over the wheel well of the ambulance in order to provide more room to work alongside the patient. In some embodiments, all or a portion of the track for the maneuverable chair may be located on a vertical surface, such as the wall of the ambulance. The present invention embraces other methods of supporting a maneuverable chair known to those skilled in the art, such as a ceiling-mounted support structure and track.

In some embodiments, the chair also swivels 180 degrees. This allows the ambulance attendant to retrieve supplies, while remaining secured in the chair. In other embodiments, the chair swivels 360 degrees, allowing the ambulance technician to turn the chair in either direction, while also being able to selectively lock the chair into one position in order to retain stability. In still other embodiments, the chair tilts up and down and from side to side, allowing the attendant to selectively position him/herself. In all configurations, the chair restrains the attendant, keeping him or her safe in the case of abrupt changes in direction or even in accidents.

While some embodiments have manual releases, which allow the attendant to manually control the movement of the chair, other embodiments allow the chair to move via power. One such embodiment uses a ball and screw mechanism and allows the chair to move with power along the track.

In other embodiments, the layout of the entire rear portion of the ambulance positions items close enough to the attendant that he/she can reach any item while remaining restrained in the chair.

While the methods and processes of the present invention have proven to be particularly useful in the area of ambulances, those skilled in the art can appreciate that the methods and processes can be used in a variety of different applications and in a variety of different areas of manufacture to yield similar safety-related benefits.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a plan view of a representative maneuverable ambulance chair in a representative ambulance;

FIG. 2 illustrates a side perspective view of a representative maneuverable ambulance chair;

FIG. 3 illustrates a perspective view of representative maneuverable ambulance chairs in an ambulance;

FIG. 4 illustrates a perspective view of a representative maneuverable ambulance chair;

FIG. 5 illustrates a perspective view of representative maneuverable ambulance chairs in an ambulance;

FIG. 6 illustrates a perspective view of a representative maneuverable ambulance chair in an ambulance;

FIG. 7 illustrates a plan view of a representative ambulance having representative maneuverable ambulance chairs;

FIG. 8 illustrates a plan view of a representative ambulance having representative maneuverable ambulance chairs;

FIG. 9 illustrates a perspective view of a representative maneuverable ambulance chair;

FIG. 10 illustrates a perspective view of a representative maneuverable ambulance chair; and

FIG. 11 illustrates a plan view of a representative ambulance layout including several maneuverable ambulance chairs.

### DETAILED DESCRIPTION OF THE INVENTION

The present invention relates to a maneuverable ambulance chair. More particularly, the present invention relates to a chair that allows an ambulance attendant to safely attend to a patient because the chair is both secured to the floor of an ambulance and maneuverable, allowing an ambulance attendant access to the patient at any number of positions while remaining safely restrained in the chair.

In the disclosure and in the claims the term “chair” shall refer to “any chair-like device that allows a person to sit or stand and that functions to both restrain a person and allows sufficient mobility to be able to attend to a patient.”

In the disclosure and in the claims the term “ambulance” shall refer to “any transportation vehicle including cars, trucks, planes, helicopters, motorhomes and the like that would benefit from the maneuverable ambulance chair.”

In the disclosure and in the claims the terms “track” and “channel” shall be interchangeable and shall refer to “any device known to one skilled in the art that facilitates the selective directed movement of a chair along a surface.”

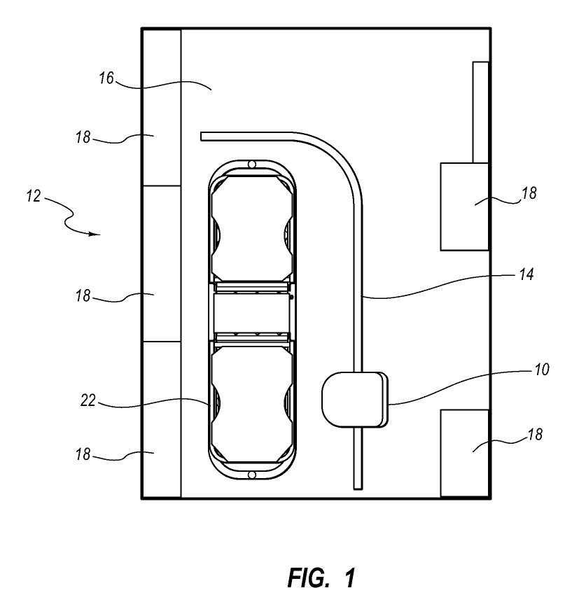

Referring now to the embodiment shown in FIG. 1, a maneuverable ambulance chair 10 is shown housed within a rear portion of an ambulance 12. Unlike prior art ambulance chairs or benches, the maneuverable ambulance chair 10 is maneuverable and is provided with restraining means (not shown) for restraining an ambulance attendant (not shown) in the maneuverable ambulance chair 10. The restraining means includes any seat belt or restraining device known in the relevant art that effectively restrains a person in a seat while allowing him or her sufficient movement to be able to work on a patient. This includes lap belts, lap and shoulder belt combinations, 4-point and 5-point safety harnesses, and any other restraining devices currently known or later invented for restraining an occupant in the maneuverable ambulance chair 10 while providing sufficient arm and/or upper torso movement to attend to a patient.

This embodiment also shows a track 14 on a floor 16 of the rear portion of the ambulance 12. The maneuverable ambulance chair 10 is connected to the track 14 and can move laterally in either direction on all portions of the track 14. Such movement allows an ambulance attendant (not shown) seated in the maneuverable ambulance chair 10 to position him/herself in a large variety of positions alongside or at the head of a patient (not shown) in a cot 22. In some embodiments, the maneuverable ambulance chair 10 may selectively rotate 180 or 360 degrees at any particular position on the track 14. This allows the attendant the ability to easily access any supplies or other materials needed to attend to the patient, even if the supplies are located to the side of or behind the attendant, such as in cabinets 18.

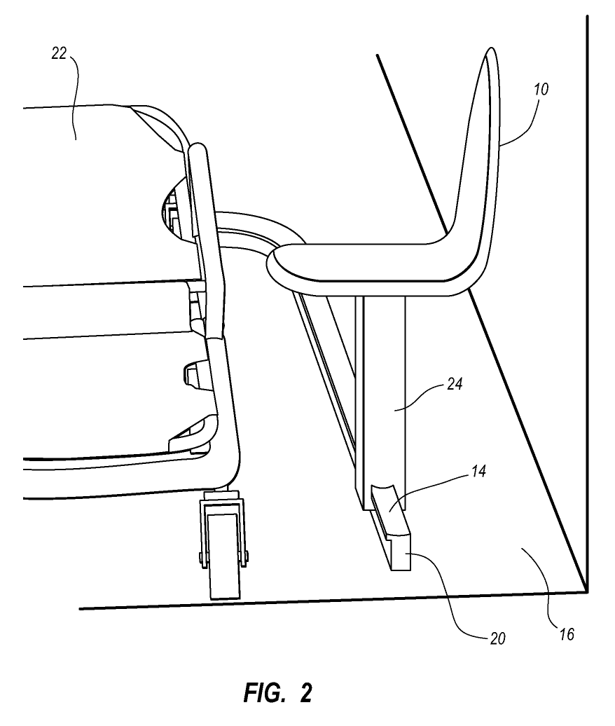

FIG. 2 is a perspective view of one embodiment of the maneuverable ambulance chair 10 as it is connected to the track 14. In this particular embodiment, the track 14 is elevated from the floor 16. However, as one skilled in the art may appreciate, the track 14 may also be integrally formed within the floor 16 or even housed within a recessed channel. The track 14 or channel may have a cross-sectional shape 20 such as is shown in FIG. 2. Although one cross-sectional shape 20 is shown, the track 14 may have any cross-sectional shape that allows the maneuverable ambulance chair 10 to selectively engage the track 14 to selectively secure the maneuverable ambulance chair 10 against unwanted movement. In any event, this embodiment allows the maneuverable ambulance chair 10 to selectively move on the track 14 so that the ambulance attendant can appropriately position him/herself relative to the cot 22. The maneuverable ambulance chair 10 shown in this embodiment has a single primary support member 24 that connects the chair 10 to the track 14. The primary support member 24 may be shaped so as to provide the selective engagement with the track 14 to secure the maneuverable ambulance chair 10 against unwanted lateral movement.

When movement of the maneuverable ambulance chair 10 is desired, the maneuverable ambulance chair 10 may be allowed to relatively freely slide along track 14 to the desired location alongside or at the head of the patient on the cot 22, as may be appreciated by reference to FIGS. 1 and 2. If the maneuverable ambulance chair 10 is capable of swiveling, the maneuverable ambulance chair 10 may also be rotationally positioned so as to best accommodate the needs of the ambulance attendant and patient, whether the ambulance attendant is working on the patient on the cot, reaching for supplies, or merely facing in the safest direction during ambulance travel. When movement of the maneuverable ambulance chair 10 is not wanted, the maneuverable ambulance chair 10 may frictionally engage the track 14, or the maneuverable ambulance chair 10 may lockingly engage the track 14 such as with a track 14 having notches (not shown) to prevent such movement. One of skill in the art will readily appreciate the many ways in which the maneuverable ambulance chair 10 may be selectively restrained against unwanted movement along track 14, all of which ways are embraced by the invention.

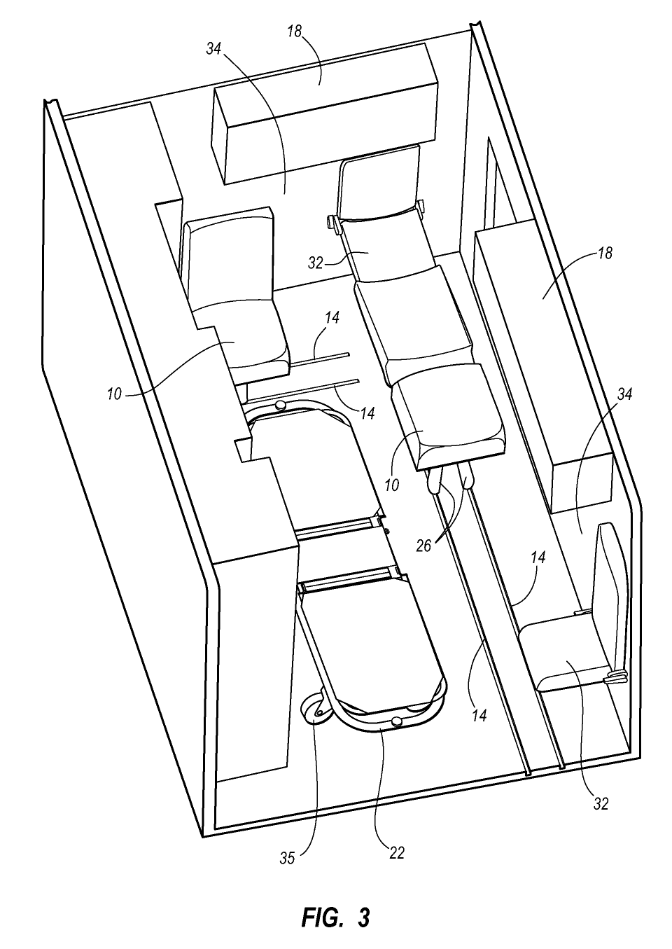

FIG. 3 depicts an embodiment of the present invention that contemplates multiple maneuverable ambulance chairs 10. In some embodiments, the maneuverable ambulance chair 10 may be capable of reclining, as is shown with one of the maneuverable ambulance chairs 10 in FIG. 3. In still other embodiments, the chair may be capable of tilting up and down and/or from side to side, allowing the attendant to selectively position him/herself to best serve the needs of the patient and attendant. Other embodiments allow an attendant to raise or lower the maneuverable ambulance chair, or allow any combination of the described maneuvering.

The embodiment of FIG. 3 also shows a chair 10 that has multiple support members 26 that connects the chair 10 to multiple tracks 14. As one skilled in the art knows, there are many manners in which the chair 10 can be connected to the track 14, using both single and multiple supports to connect the chair 10 to the track 14. This embodiment also shows cabinets 18 that are conveniently positioned such that an ambulance attendant (not shown) seated in the maneuverable ambulance chair 10 can access the cabinets 18 without releasing his or her restraining means (not shown). This embodiment also shows a foldable chair 32 affixed to an ambulance wall 34. The presence of foldable chair 32 allows for additional ambulance attendants to ride safely in the rear portion of the ambulance 12. This embodiment also shows an example of cot 22. This particular cot 22 has wheels 35.

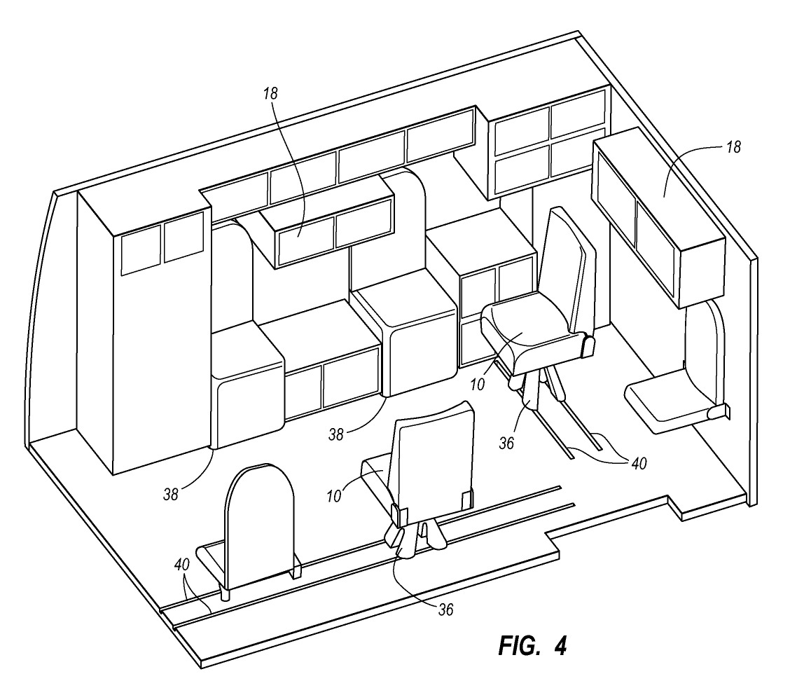

FIG. 4 shows another embodiment of the present invention that contemplates multiple maneuverable ambulance chairs 10. The maneuverable ambulance chairs 10 shown in this embodiment have a quad-support system 36 that connects the chairs 10 to the track 14, providing added stability and security. In addition, this embodiment shows non-foldable chairs 38 that are positioned next to and in between cabinets 18. In this embodiment, not only can the ambulance attendant seated in maneuverable ambulance chair 10 easily access cabinets 18, but non-foldable chairs 38 are also positioned such that ambulance attendants seated therein can also easily access the cabinets 18. In some embodiments, non-foldable chairs 38 may be replaced with additional cabinets 18, with foldable chairs 32, or even with another maneuverable ambulance chair 10 on a separate track 14, depending on the desired configuration and available room in ambulance 12.

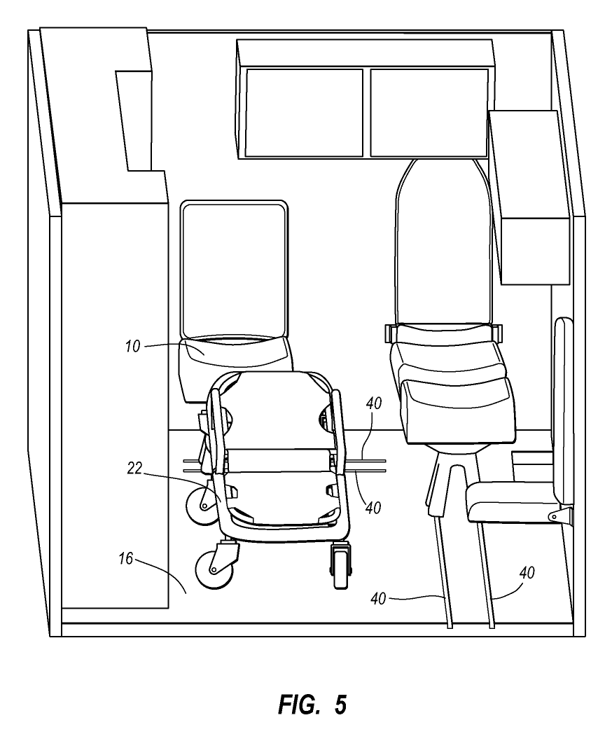

FIG. 5 shows an embodiment of the present invention where the tracks 14 comprise recessed channel 40. Using recessed channels 40 as the tracks or channels is sometimes preferable in some embodiments because they create less risk that ambulance attendants will trip. In addition, they are preferable in those embodiments where ambulance attendants must slide other materials along portions of the floor 16 unoccupied by the cot 22 and chair 10.

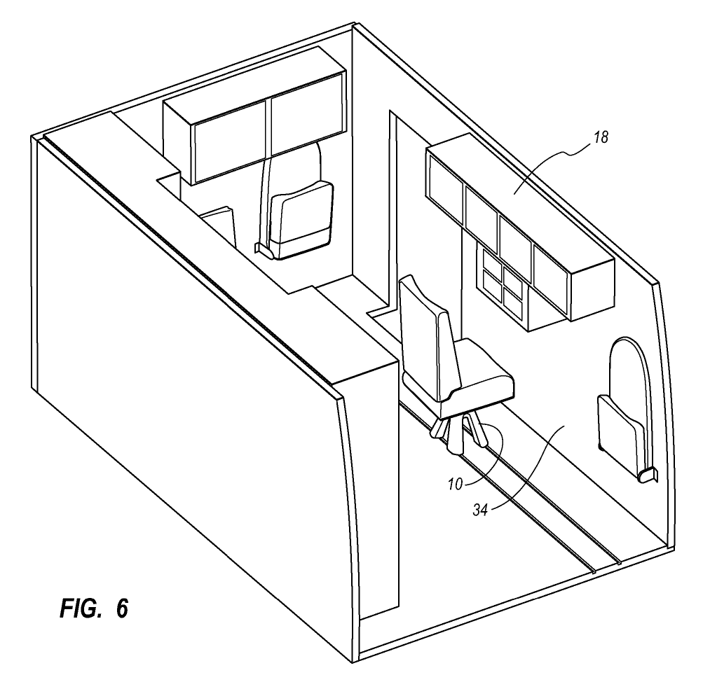

FIG. 6 shows an embodiment of the present invention where the maneuverable ambulance chair 10 has rotated 180 degrees so that it is facing the ambulance wall 34. In embodiments where the maneuverable ambulance chair 10 can rotate, the ambulance attendant can easily access any materials needed from cabinets 18 located behind and/or over the head of the ambulance attendant.

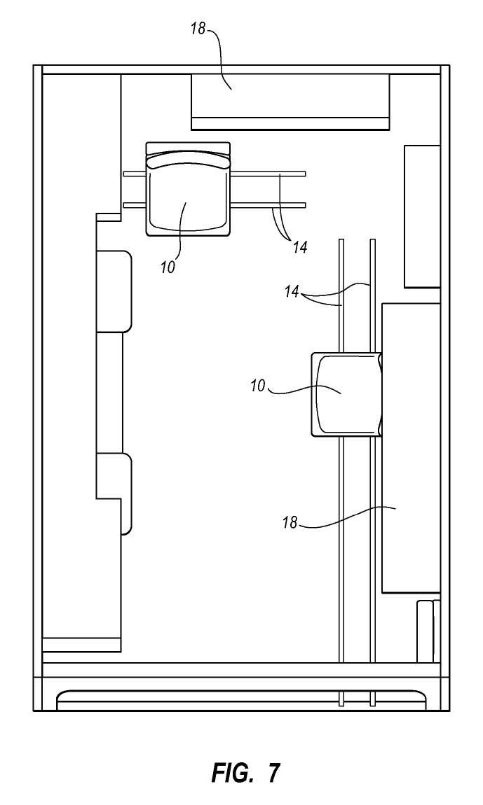

FIG. 7's plan view of an embodiment of the present invention shows how close tracks 14 allow the chair 10 to be to cabinets 18. Thus, ambulance attendants can attend to patient (not shown) on cot 22 (not shown) and retrieve needed medical instruments from cabinets 18, while remaining safely secured by the restraining means of the maneuverable ambulance chair 10.

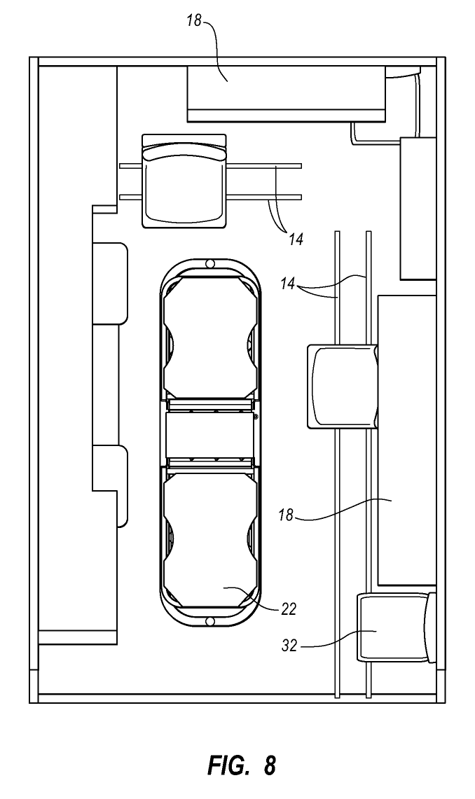

FIG. 8's plan view is similar to the embodiment of FIG. 7, except that it includes cot 22 and shows foldable chair 32 in an unfolded position.

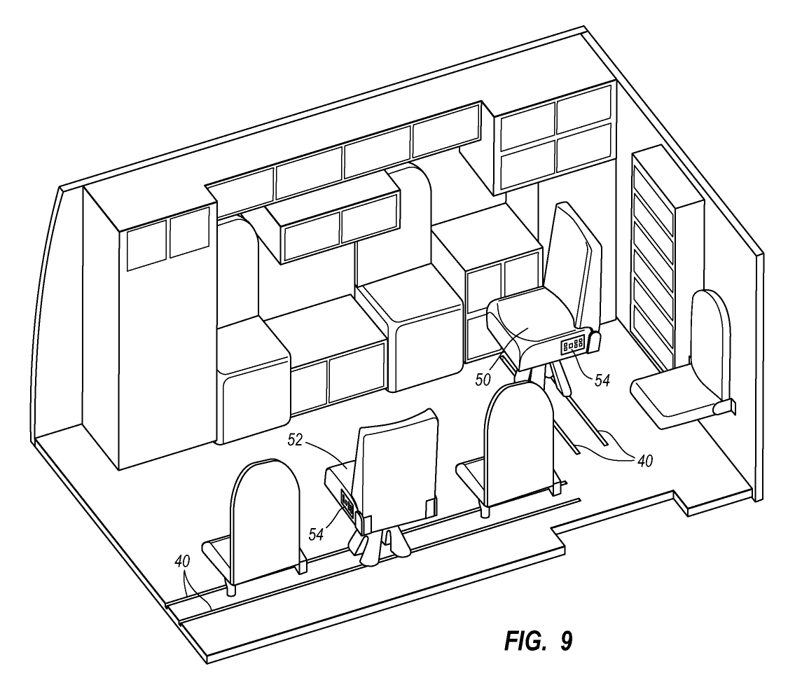

FIG. 9 shows an embodiment of the present invention that includes a captain's chair 50 and an attendant's chair 52 that have controls 54 for the rear portion of the ambulance 12. Controls 54 include any number of switches, buttons, etc. that may be useful to ambulance attendants. A non-limiting list includes switches for air-conditioning, heat, interior light controls and even a panic button, should patient become combative. In addition, controls 54 may include switches for controlling the position of the chairs 50 and 52 or for controlling the releasing and engagement of the chairs 50 and 52 to allow the ambulance attendants to reposition the chairs 50 and 52 as needed.

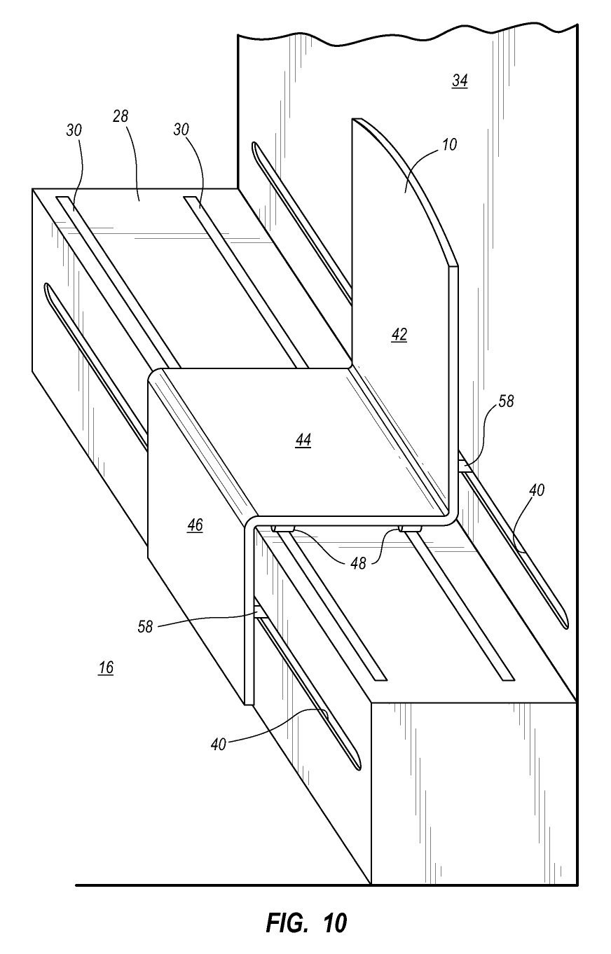

In some embodiments, the available room in the back of an ambulance 12 may be limited, and the space occupied by the maneuverable ambulance chair 10 should be limited so as to provide more room for the cot 22 and patient. In instances where space is at a premium, an embodiment of the maneuverable ambulance chair 10 such as that depicted in FIG. 10 may be provided. As with previous depictions of the various embodiments, it is envisioned that restraining means may be incorporated into the depicted embodiment of the maneuverable ambulance chair 10. In the depicted embodiment, a bench 28 replaces a seating bench commonly found in ambulances 12. The bench 28 includes one or more hard-surfaced roller tracks 30 which form a part of track 14 in this embodiment.

The maneuverable ambulance chair 10 in this embodiment includes a back portion 42, a seat portion 44, and a leg portion 46. Other embodiments are envisioned that include only a seat portion 44 or only a seat portion 44 with either a leg portion 46 or a back portion 42. In the depicted embodiment, the seat portion 44 is provided with rollers 48 that rest on and roll over the roller track(s) 30 of the bench 28. This allows the maneuverable ambulance chair 10 to easily move from side to side when desired to better access a patient and/or supplies. The ambulance wall 34 and the side wall 56 of the bench 28 may be provided with recessed channels 40 similar to the recessed channels discussed previously with respect to FIG. 5. Attached to the back portion 42 and the leg portion 46 of the maneuverable ambulance chair 10 are locking guide members 58 that slide within the recessed channels 40 when the maneuverable ambulance chair 10 moves from side to side, but that lock within the recessed channels as desired to secure the maneuverable ambulance chair 10 against unwanted movement, similar to those systems described above. Although an embodiment has been depicted having two recessed channels 40, other embodiments may have only one recessed channel 40, while still other embodiments may have more than two recessed channels 40.

In embodiments lacking a back portion 42 and/or a leg portion, a single recessed channel 40 may be provided engaging only the remaining portion 42, 44, or 46, or multiple recessed channels 40 may be provided to engage locking guide members 58 on the remaining portions 42, 44, or 46. Additionally, the recessed channel 40 may be provided as part of the top of the bench 28, and may be close to or integrally formed with the roller track(s) 30. In some embodiments, a release mechanism (not shown) may be provided to allow the attendant to selectively release and engage the maneuverable ambulance chair 10 to allow for desired movement and then a desired fixed location. Although the embodiments discussed with respect to FIG. 10 were discussed using recessed channels 40, it is envisioned that other embodiments may alternatively or jointly use an elevated track 14 similar to the tracks 14 previously discussed.

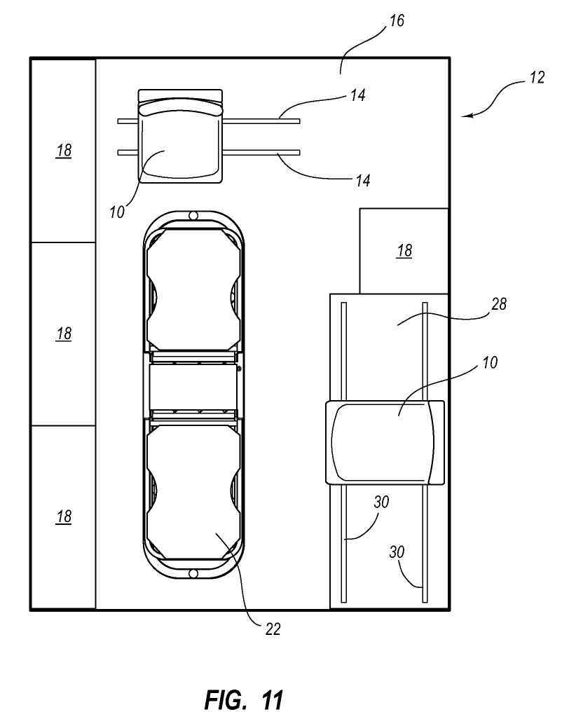

As may be appreciated by reference to FIG. 11, which is a plan view of an ambulance including an embodiment of the maneuverable ambulance chair 10 similar to the embodiments discussed with respect to FIG. 10, some embodiments provide a maximal amount of floor space in the ambulance 12 not taken up by the maneuverable ambulance chair 10. This is partially accomplished because the bench 28 of the embodiments of the maneuverable ambulance chair 10 depicted in FIGS. 10-11 may partially cover the already-lost floor space commonly taken by the wheel well of the ambulance 12. As may be appreciated by one of skill in the art, the various embodiments of the invention may be combined as is depicted in FIG. 11, with one maneuverable ambulance chair 10 being a floor-mounted model, and one maneuverable ambulance chair 10 being a bench-mounted model. All maneuverable ambulance chairs 10 may have varying track and/or path lengths as desired to best serve a particular ambulance's and attendant's needs.

Although embodiments have been discussed where the track 14 is located on the floor 16, on an elevated bench 28, or on a wall 34 of the ambulance 12, still other embodiments are envisioned where the track 14 is located above the maneuverable ambulance chair 10, such as high on the wall 34 of the ambulance 12, or even on a ceiling of the ambulance 12. Such an arrangement may be particularly advantageous to eliminate obstructions along the floor of an ambulance to prevent attendants from tripping and to prevent difficulties when loading or unloading a patient and cot 22. One of skill in the art will readily appreciate how to provide a track 14 that is an overhead track or ceiling-mounted support structure that adequately supports a maneuverable ambulance chair 10 against unwanted movement, such as during sudden direction changes, acceleration or deceleration, bumps, or ambulance accidents.

In many embodiments of the invention, it is desirable to provide the maneuverable ambulance chair 10 with the ability to passively engage and actively release from the track 14. This means that the maneuverable ambulance chair 10 is typically automatically locked against unwanted movement as long as the attendant is passive, i.e. doing nothing to release the maneuverable ambulance chair 10. To release the maneuverable ambulance chair 10 and allow movement, the attendant must actively actuate a release mechanism and then hold the mechanism in its released state until the maneuverable ambulance chair 10 is in the desired location. When the maneuverable ambulance chair 10 is in the proper location, the attendant simply releases or stops holding the mechanism in its released state, and the mechanism automatically re-engages the track 14 to prevent further movement. This safety feature better prevents unwanted movement in manual systems, as it is more difficult to accidentally cause movement, and if a sudden unexpected ambulance movement occurs and the attendant releases the mechanism, the maneuverable ambulance chair 10 is automatically secured against further motion.

While some embodiments have manual releases, which allow the attendant to manually control the movement of the maneuverable ambulance chair 10, other embodiments allow the maneuverable ambulance chair 10 to move via a powered mechanism. One such embodiment uses a ball and screw mechanism that allows the chair to move with power along the track. In such embodiments, the ball and screw may be located within the recessed channel 40, and the attendant actuates the screw to move the maneuverable ambulance chair 10 to the desired location. Once stopped at the desired location, the screw and ball or other powered mechanism prevents further unwanted movement of the maneuverable ambulance chair 10.

Thus, as discussed herein, the embodiments of the present invention embrace a chair that allows an ambulance attendant to safely attend to a patient because the chair is both secured to the floor, wall, or other structure of the ambulance and maneuverable, allowing an ambulance attendant access to the patient at any number of positions while remaining secured in the chair.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A system for safely attending to patients in an ambulance comprising:
a patient cot located in the ambulance;
a chair track in an ambulance, the chair track being located so as to position a chair attached to the chair track proximate the patient cot;
a maneuverable ambulance chair slidably connected to the chair track and selectively positionable along the chair track;
restraining means for restraining an ambulance attendant seated in the maneuverable ambulance chair; and
a securing mechanism reversibly fixing the position of the maneuverable ambulance chair on the chair track to prevent unwanted movement of the maneuverable ambulance chair along the chair track.

2. The system of claim 1, wherein the securing mechanism comprises a passive engage, active release mechanism.

3. The system of claim 1, wherein the maneuverable ambulance chair is capable of swiveling.

4. The system of claim 1, wherein the chair track is at least partially located over a wheel well of the ambulance.

5. The system of claim 1, wherein the chair track is a curved track allowing the maneuverable ambulance chair to be located at positions along the side of and at the head of the patient cot.

6. The system of claim 1, wherein the restraining means comprises a lap belt.

7. The system of claim 1, wherein the chair track is a straight track allowing the maneuverable ambulance chair to be located at positions along the side of the patient cot.

8. The system of claim 7, wherein the chair track is a first track and the maneuverable ambulance chair is a first maneuverable ambulance chair, further comprising:
a second track allowing a second maneuverable ambulance chair to be located at positions adjacent the head of the patient cot; and
a second maneuverable ambulance chair slidably connected to the second track, selectively positionable along the second track, and including a second securing mechanism and a second restraining means for restraining a second ambulance attendant.

9. The system of claim 1, wherein the chair track is located on the floor of the ambulance.

10. The system of claim 1, wherein the ambulance attendant manually releases the maneuverable ambulance chair and manually slides the maneuverable ambulance chair along the chair track to a desired position.

11. The system of claim 1, wherein the positioning of the maneuverable ambulance chair is done via a powered mechanism.

12. The system of claim 1, wherein the track comprises a recessed channel.

13. A method for safely attending to patients in an ambulance comprising:
providing a track located in an ambulance;
providing a maneuverable ambulance chair that is slidably connected to the track;
selectively positioning the maneuverable ambulance chair along the track; and
restraining an ambulance attendant in the maneuverable ambulance chair using a restraining means for restraining the ambulance attendant, wherein the restraining means is coupled to the maneuverable ambulance chair and wherein the ambulance attendant can attend to a patient located in a cot in the ambulance without removing the restraining means regardless of the position the maneuverable ambulance chair is at along the track.

11. The method of claim 10, further comprising retrieving medical supplies from a cabinet without removing the restraining means.

12. A maneuverable ambulance chair that allows an ambulance attendant to attend to a patient at various locations proximate the patient while the ambulance attendant remains secured in the maneuverable ambulance chair and protected against accidents and unexpected movement of an ambulance, comprising:
a chair track positioned in and attached to an ambulance proximate a location in the ambulance used to hold a patient cot; and
a chair slidably connected to the chair track comprising:
a seat;
restraining means for restraining an ambulance attendant seated in the chair; and
securing means coupled to the seat for reversibly fixing the position of the chair on the chair track against unwanted chair movement;
wherein the ambulance attendant can position the chair at a position on the chair track to attend to the needs of a patient on the patient cot and secure the chair in the position against unwanted chair movement without releasing the restraining means.

13. The maneuverable ambulance chair of claim 12, wherein the chair track is an elevated track positioned at least in part above a wheel well of the ambulance.

14. The maneuverable ambulance chair of claim 12, wherein the chair further comprises rollers that roll over at least a portion of the chair track.

15. The maneuverable ambulance chair of claim 12, wherein the restraining means comprises a seat belt.

16. The maneuverable ambulance chair of claim 12, wherein the seat further comprises a back.

17. The maneuverable ambulance chair of claim 12, wherein the chair is adjustable in at least one of the following ways:
swiveling;
reclining;
tilting; and
raising and lowering.

18. The maneuverable ambulance chair of claim 12, wherein the chair further comprises a support member between the seat and the securing means.

19. The maneuverable ambulance chair of claim 12, wherein the securing means comprises a passive engage, active release mechanism.

20. The maneuverable ambulance chair of claim 12, wherein the chair track comprises a recessed channel and wherein the seat further comprises a locking guide member engaging the recessed channel.
